(19) United States
(12) Patent Application Publication
(10) Pub. No.: US 2017/0118686 A1
(43) Pub. Date: Apr. 27, 2017

(54) EMF IMPACT TRIGGERED REPORTING AND CELL SELECTION

(71) Applicant: FUJITSU LIMITED, Kawasaki-shi (JP)

(72) Inventors: Yiwei FANG, High Wycombe (GB); Timothy MOULSLEY, Caterham Surrey (GB); Paul BUCKNELL, Brighton (GB)

(21) Appl. No.: 15/289,536

(22) Filed: Oct. 10, 2016

(30) Foreign Application Priority Data
Oct. 21, 2015 (GB) 1518687.7

(51) Int. Cl. H04W 36/08; H04W 36/36; H04W 36/00

(52) U.S. Cl. CPC H04W 36/08; H04W 36/0083; H04W 36/36

(57) ABSTRACT

A User Equipment (10) in a wireless communication network reports measurements or selects cells based on the EMF exposure to one or more persons in those cells, estimated to result on the uplink (UL) and/or downlink (DL) due to the UE's use of those cells. The network sends indications to the UE, in order to allow the UE to understand the EMF impact generated when the UE is connected to certain cells. For the downlink, these indications may include an EMF impact indicator or a UL beamforming reception capability indicator. For application to LTE, a new event triggered UE measurement reporting criterion is proposed to allow the UE to report measurements based on a new EMF related metric and to trigger measurement reports with regards to the EMF impact. The new EMF-based measurement reports allow the cell selection/reselection process to take into account minimization or optimization of the EMF impact on the environment.

### FIELD OF THE INVENTION

The present invention relates to a terminal for use in a wireless communication system. The present invention further relates to the wireless communication system itself, a base station for use in the wireless communications system, and a wireless communication method.

Particularly, but not exclusively, the present invention relates to techniques for assisting a terminal to select a cell for handover or measurement reporting in a wireless communication system which may be compliant with the LTE (Long Term Evolution) and LTE-Advanced radio technology standards, for example as described in Release 12 (Rel-12) and subsequent of the 3GPP specification series.

### BACKGROUND OF THE INVENTION

Wireless communication systems are widely known in which terminals (also called user equipments or UEs, subscriber or mobile stations) communicate with base stations (BSs) within range of the terminals.

The geographical areas served by one or more base stations are generally referred to as cells, and typically many BSs are provided in appropriate locations so as to form a network (Radio Access Network or RAN) covering a wide geographical area more or less seamlessly with adjacent and/or overlapping cells. (In this specification, the terms “system” and “network” are used synonymously). Each BS may support or provide one or more cells (including cells formed by Remote Radio Heads (RRHs) which are linked to the BS via a fixed link such as a fibre optic cable). In each cell, the BS typically divides its available bandwidth, i.e. frequency and time resources, into individual resource allocations for the user equipments which it serves. The terminals are generally mobile and therefore may move among the cells, prompting a need for handovers between the base stations of adjacent cells. A terminal may be in range of (i.e. able to detect signals from and/or communicate with) several cells at the same time, but in the simplest case it communicates with one “serving” cell.

One type of cellular wireless network is based upon the set of standards referred to as Long-Term Evolution (LTE). The current version of the standard, Release 11 (Rel 11), is also referred to as LTE-A (LTE-Advanced), and the specifications for Release 12 are currently being finalised. The network topology in LTE is illustrated in FIG. 1. As can be seen, each terminal 10, called a UE in LTE, connects wirelessly over an air interface (labelled Uu in FIG. 1) to a base station in the form of an enhanced node-B or eNB 20. It should be noted that various types of eNB are possible. An eNB may support one or more cells at different carrier frequencies, each cell having differing transmit powers and different antenna configurations, and therefore providing coverage areas (cells) of differing sizes. Multiple eNBs deployed in a given geographical area constitute a wireless network called the E-UTRAN (and henceforth generally referred to simply as “the network”). An LTE network can operate in a Time Division Duplex, TDD, mode in which the uplink (UL) and downlink (DL) are separated in time but use the same carrier frequency, or Frequency Division Duplex, FDD, in which the uplink and downlink occur simultaneously at different carrier frequencies. Radio Resource Control (RRC) is a protocol layer in the UE and eNB to control various aspects of the air interface, including establishing, maintaining and releasing a RRC connection between the UE and eNB. Thus, for a UE to be served by a cell implies a RRC connection with the eNB providing or controlling that cell.

Each eNB 20 in turn is connected by a (usually) wired link (S1 in FIG. 1) to higher-level or “core network” entities 101, including a Serving Gateway (S-GW), and a Mobility Management Entity (MME) for managing the system and sending control signalling to other nodes, particularly eNBs, in the network. In addition (not shown), a Packet Data Network (PDN) Gateway (P-GW) is present, separately or combined with the S-GW, to exchange data packets with any packet data network including the Internet. Thus, communication is possible between the LTE network and other networks. A further node (not shown) is called an Operation, Administration, and Maintenance (OAM) system and is responsible for managing the network and co-operation between different RANs. Meanwhile, the eNBs can communicate among themselves via a wired or wireless X2 interface as indicated in the Figure.

FIG. 1 shows what is sometimes called a “homogeneous network”; that is, a network of base stations in a planned layout and which have similar transmit power levels, antenna patterns, receiver noise floors and similar backhaul connectivity to the core network. Current wireless cellular networks are typically deployed as homogeneous networks using a macro-centric planned process. The locations of the base stations are carefully decided by network planning, and the base station settings are properly configured to maximise the coverage and control the interference between base stations. Traditionally, “drive tests” were used for collecting data needed for the configuration and the maintenance of the networks, involving humans physically driving around the geographical area covered by the network and making measurements using specialised measuring equipment. More recently, a so-called Minimization of Drive Test (MDT) employs the devices (terminals) in the network to provide the necessary measurements. The reporting by UEs for MDT is controlled by the OAM system.

Future cellular wireless networks will adopt a “heterogeneous network” structure composed of two or more different kinds of cell, one arrangement also being referred to as a Small Cell Network or SCN.

The motivation for SCNs is the idea of network densification: increasing the number of network nodes, and thereby bringing them physically closer to the terminals, in order to improve traffic capacity and extending the achievable user-data rates of a wireless communication system. SCNs achieve network densification by the deployment of complementary low-power nodes under the coverage of an existing macro-node layer. In such a heterogeneous deployment, the low-power nodes provide very high traffic capacity and very high user throughput locally, for example in indoor and outdoor hotspot positions. Meanwhile, the macro layer ensures service availability and Quality of Experience (QoE) over the entire coverage area. In other words, the layer containing the low-power nodes can also be referred to as providing local-area access, in contrast to the wide-area-covering macro layer.

FIG. 2 depicts a simple SCN. The large ellipse represents the coverage area or footprint of a Macro cell provided by a base station (Macro BS) 20. The smaller ellipses represent small cells (such as Pico or Femto cells) within the coverage area of the Macro cell, each having a respective low-power base station 21-26 (exemplified by Pico BS 21). Here, the Macro cell is a cell providing a “macro layer” of basic coverage in the network of a certain area, and the small cells are overlaid over the Macro cell, using the same or different carrier frequencies, providing a “low-power layer” for capacity boosting purposes particularly within so-called hot spot zones. A UE 10 is able to communicate both with Macro BS 20 and Pico BS 21 as indicated by the arrows in the Figure.

In SCN scenarios, the Macro BS can be a mobility anchor point for the UE, providing the control signalling for handovers of the UE between small cells. Whilst a Pico BS 21 is shown by way of example, it should be noted that various types of station can provide the small cells, including Home eNBs (HeNBs) providing Femto cells, or even other UEs if these can operate in a device-to-device (D2D) mode. Thus, other base stations 22-26 shown in FIG. 2 could form other Pico cells or alternatively, Femto cells which are even lower power and smaller range than the Pico cell around pico base station 21. Any such cells are henceforth referred to simply as “small cells”.

It should be noted that the presence of a Macro cell is not essential and the SCN may consist only of small cells. In any case, however, coordination among the cells at the same or nearby location is required and this is conveniently provided by a primary eNB such as the Macro BS 20 even for UEs not directly connected to the Macro BS.

Incidentally, small cells can be configured in either of an Open Access mode or a closed subscriber group (CSG) mode. In closed subscriber group (CSG) mode, only those users included in the small cell's access control list are allowed to access the cell, whilst in Open Access mode any user is allowed access. A CSG identity is broadcast by a small cell in CSG mode. So-called hybrid access is also possible: this is a variant of open access where any UE normally has access to the cell but the cell also operates as a CSG cell, giving priority of services to members of the CSG when congestion occurs.

To assist in understanding the invention to be described, some explanation will now be given of the E-UTRAN layers for data and signalling, which are defined at various levels of abstraction within an LTE network.

FIG. 3 shows some of the protocol layers defined in LTE at each of a physical channel level (Layer 1); transport channel level, logical channel level, radio bearer level and control traffic level (together forming Layer 2); and the Layer 3 levels of radio resource control and Non-Access Stratum (NAS) for the control plane and Internet Protocol (IP) for the user traffic.

On the downlink, at the physical layer level, each cell conventionally broadcasts a number of channels and signals to all UEs within range, whether or not the UE is currently being served by that cell. Of particular interest for present purposes, these include a Physical Broadcast Channel PBCH. PBCH carries a so-called Master Information Block (MIB), which gives, to any UEs within range of the signal, basic information as described below. Primary and Secondary Synchronization Signals (PSS/SSS) are also broadcast to all devices within range. In addition to establishing a timing reference for a cell, these carry a physical layer cell identity (PCI) and physical layer cell identity group for identifying the cell.

In LTE specifications, a UE can be considered as either synchronised or unsynchronised with respect to a cell. Successfully decoding the PSS and SSS allows a UE to obtain the synchronization information, including downlink timing and cell ID for a cell; in other words the UE becomes “synchronized” with the cell. In the synchronized state, the UE can transmit signals in the uplink (assuming resources are made available by the network), with a defined timing (the uplink timing is obtained by subtracting a “timing advance” TA from the downlink timing).

Once a UE has decoded a cell's PSS and SSS it is aware of the cell's existence and may decode the MIB in the PBCH referred to earlier. The PBCH is transmitted every frame, thereby conveying the MIB over four frames. The MIB includes some of the basic information which the UE needs to join the network, including system bandwidth, number of transmit antenna ports, and system frame number (SFN). Reading the MIB enables the UE to receive and decode the System Information Blocks (SIBs).

The first System Information Block (SIB1) is relevant when evaluating if a UE is allowed to access a cell. When a UE-to-cell association is formed, the UE can begin to receive user data (packets) from the cell (or serving cell), and/or transmit user data to the cell. The second System Information Block (SIB2) contains radio resource configuration information that is common for all UEs. It contains access barring information, radio resource configuration of common and shared channels, timers and constants which are used by UEs, uplink power control information etc. SIB2 also gives information about the uplink carrier frequency and the uplink channel bandwidth in terms of number of Resource Blocks.

The UE may take actions such as cell selection or measurement reporting based on measurement made on the cells that it can detect.

An important class of measurements is used for Radio Resource Management (RRM) and these are typically used by the network as the basis for determining which cell(s) should serve a given UE. So far the typical criteria used by the network include received radio signal power (RSRP) and received radio signal quality (RSRQ) for each cell.

RSRP is measured by the UE and is an averaged value of the received power of a reference signal for all the Resource Elements occupied by that reference signal. By contrast, another measure of power, Energy Per Resource Element (EPRE), as the name suggests, indicates power transmitted by a cell for a given reference signal in one resource element (RE). EPRE can be derived by the UE from the parameter referenceSignalPower provided by higher layers.

RSRQ is defined as the ratio of RSRP to the E-UTRAN carrier RSSI (Received Signal Strength Indicator). These measurements can give a good indication of the likely suitability of a given cell based on downlink (DL) transmission, but do not consider the EMF that a UE using a given cell is likely to generate.

In the UE, the PHY layer performs measurements and reports measured data to the Radio Resource Control (RRC) layer. RRC performs Layer 3 filtering (if configured) for example by applying a rolling average to the measurements, to ensure that a single, unusually high or low measurement does not trigger an undesired action. Then the result is used for the evaluation of the reporting criteria, which determines whether the measurement reporting is triggered. More background relating to these aspects is provided below.

In a LTE system, a UE may report various information to the network. Depending on the measurement type, the UE may measure and report RSRP and/or RSRQ for any of the following:
The serving cell;
Listed cells (i.e. cells indicated as part of the measurement object);
Detected cells on a listed frequency (i.e. cells which are not listed cells but are detected by the UE).

For some RATs (Radio Access Technologies), the UE measures and reports listed cells only (i.e. the list is a whitelist), while for other RATs the UE also reports detected cells. Additionally, E-UTRAN can configure UTRAN PCI ranges for which the UE is allowed to send a measurement reports (mainly for the support of handover to UTRAN cells broadcasting a CSG identity).

For LTE, the following event-triggered reporting criteria are specified (referring to RSRP and/or RSRQ of a cell):
Event A1. Serving cell becomes better than absolute threshold (in other words, RSRP or RSRQ of the serving cell exceeds a threshold value specified by the network).
Event A2. Serving cell becomes worse than absolute threshold.
Event A3. Neighbour cell becomes better than an offset relative to the serving cell.
Event A4. Neighbour cell becomes better than absolute threshold.
Event A5. Serving cell becomes worse than one absolute threshold and neighbour cell becomes better than another absolute threshold.

For inter-RAT mobility, the following event-triggered reporting criteria are specified:
Event B1. Neighbour cell becomes better than absolute threshold.
Event B2. Serving cell becomes worse than one absolute threshold and neighbour cell becomes better than another absolute threshold.

For cell selection in Rel-8, only RSRP is used in the above criteria (referred to as “S Criteria”), but for Rel-9 and above, both RSRP and RSRQ are used to help a UE to select a cell that shows a high level of RSRP and RSRQ.

The UE triggers an event when one or more cells meets a specified ‘entry condition’. The E-UTRAN can influence the entry condition by setting the value of some configurable parameters used in these conditions—for example, one or more of the thresholds in the above list, an offset, and/or a hysteresis. The entry condition must be met for at least a duration corresponding to a ‘timeToTrigger’ parameter configured by the E-UTRAN in order for the event to be triggered. The UE scales the timeToTrigger parameter depending on its speed.

Environmental exposure to man-made electromagnetic fields has been steadily increasing as growing electricity demand, ever-advancing technologies and changes in social behaviour have created more and more artificial sources. Everyone is exposed to a complex mix of weak electric and magnetic fields, both at home and at work, from the generation and transmission of electricity, domestic appliances and industrial equipment, to telecommunications and broadcasting. The abbreviation “EMF” is used henceforth to denote both electromagnetic fields themselves, and exposure of humans to those electromagnetic fields.

It is not disputed that electromagnetic fields above certain levels can trigger biological effects. Experiments with healthy volunteers indicate that short-term exposure at the levels present in the environment or in the home do not cause any apparent detrimental effects. Exposures to higher levels that might be harmful are restricted by national and international guidelines.

One source of EMF exposure is mobile telephone use, not just to mobile users themselves but (of more relevance to the present invention) exposure to other people around the user and/or the base station. The long-term health effects of mobile telephone use are another topic of much current research. No obvious adverse effect of exposure to low level radiofrequency fields has been discovered.

It is widely anticipated that by year 2020, there will be tens of billions of devices connected to the network. For example, Ericsson predicts there will be 50 billion devices connected in year 2020. Given this large number of devices is being added to the network and people's living environment, the EMF impact from those huge number of devices is a growing concern.

In wireless communication systems, current criteria for cell selection, reselection, or handover are largely based on the optimization of performance or data rates. Little or no consideration is given to the potential EMF impact of wireless transmissions on the environment and upon persons other than the mobile device user themselves.

### SUMMARY OF THE INVENTION

According to a first aspect of the present invention, there is provided a terminal for use in a wireless communication network having one or more cells at least one of which is a serving cell or potential serving cell for the terminal and has a coverage area occupied by one or more persons at least one of whom is not a user of the terminal, the terminal comprising:
a receiver which receives messages from the network including, for each of said at least one said cell, an indication related to electromagnetic field, EMF, exposure; and
a controller which estimates, based at least on said indication, an EMF impact on at least one of said one or more persons of the terminal performing wireless communication on a downlink and/or on an uplink with said at least one said cell.

Here, a “potential serving cell” means a cell which is capable of being a serving cell for the terminal, for example by the terminal being within the coverage area of the cell for wireless communication.

By “persons who are not users of the terminal” is meant humans who are in the path of wireless communication of the terminal with the cell, rather than the user (if any) of the terminal. It is noted that the terminal will typically have a human user, but such a user need not be present (for example in the case of a MTC device).

The “indication relating to EMF” for each cell may, as explained below, relate directly to EMF. Alternatively it may relate to one or more parameters having a bearing upon EMF impact of the terminal's wireless communication with the cell.

The “EMF impact on at least one of said one or more persons of the terminal performing wireless communication on a downlink and/or on an uplink with said at least one said cell” means the exposure of such persons to electromagnetic fields estimated to result from such wireless communication of the terminal with the cell, and is referred to subsequently as simply “EMF impact”. Being an estimated quantity, it will be understood that the EMF impact is a potential, possible or likely impact. The potential EMF impact upon animals or electrical equipment can also be taken into account.

Preferably, the controller in the terminal is further arranged to generate a measurement report related to the estimated EMF impact. This may be generated either unconditionally (i.e. regardless of the size of the estimated EMF impact), or if the estimated EMF impact fulfils a criterion. Such a measurement report may include an indication of the estimated EMF impact. A report of this kind could be used, for example, to provide guidance to the network in deciding whether the terminal should be handed over to a given cell.

The controller in the terminal may be further configured for selecting a cell on the basis of at least an estimated EMF impact.

In any case, the indication received from the network preferably indicates an EMF level expected to result from the terminal receiving a transmission from the cell.

The controller may perform said estimating using at least one of:
data rate expected by the terminal;
duration of transmission expected by the terminal;
transmission power of the cell and/or of the terminal;
pathloss to the terminal and/or to the cell;
interference level at the terminal or at receive antennas of the cell;
number of transmit antennas, or antenna ports, of the cell and/or of the terminal;
number of persons within the cell coverage area and their average distance from the terminal or from transmit antennas of the cell; and
reference signal power.

According to a second aspect of the present invention, there is provided a base station providing at least one cell in a wireless communication network, the base station comprising:
a controller which obtains an indication related to EMF exposure for each of said at least one cell; and
a transmitter which transmits the indication to at least one terminal.

Here, the transmitter may be arranged to transmit the indication in system information broadcast by the base station.

Preferably the transmitter is arranged to transmit the indication by specific signalling to the terminal.

The indication transmitted by the base station may include at least one of:
a direct or relative indication of an EMF level expected to result from the terminal receiving a transmission from the at least one cell;
an indication of transmission characteristics of DL transmissions from the at least one cell;
an indication of UL reception capability of the at least one cell; and
an indication of a number of persons within the at least one cell; and
an indication of a number of persons in the vicinity of a transmission path to or from the terminal.

The controller in the base station may obtain values of reference signal power for cells provided by other base stations in the network.

The base station may further comprise a receiver arranged to receive, from the terminal, a measurement report which includes an indication of EMF impact estimated on the basis of the indication. Such a report can be used in decision-making at the controller of the base station and/or elsewhere in the network, for example regarding which cell to be used as a serving cell of the terminal.

The controller may obtain measurements of received power from terminals served by cells provided by the base station.

In any terminal or base station as defined above, the indication may apply to:
downlink;
uplink; or
downlink and uplink
   between the terminal and the base station.

According to a third aspect of the present invention, there is provided a wireless communication system comprising at least one terminal and at least one base station each as defined above.

According to a fourth aspect of the present invention, there is provided a wireless communication method comprising:
at a base station, obtaining an indication related to EMF exposure for each of at least one cell, and transmitting the indication to a terminal;
and at the terminal, receiving said indication and estimating, based at least on said indication, an EMF impact on one or more persons of the terminal performing wireless communication on a downlink and/or on an uplink with said at least one said cell.

Thus, the present invention provides a way, when selecting a cell for measurement reporting and/or handover, to take account of the EMF impact of a terminal's wireless communication, in particular the exposure of persons other than any terminal user to electromagnetic fields estimated to result from wireless communication by the terminal. Such exposure results both from DL communication (in which case it is caused by EMF of the base station) and from UL communication (in which case the EMF originates from the terminal). Thus, embodiments of the present invention can be applied to the DL, the UL, or to both.

Embodiments further provide a downlink signalling mechanism to allow the network to send indications to the terminal, in order to allow the terminal to understand the EMF impact generated when the terminal is connected to certain cells. The specific indication discussed is, in the downlink, an EMF impact indicator or a UL beamforming reception capability indicator. For application to LTE, a new event triggered terminal measurement reporting criterion is proposed to allow the terminal to report measurements based on a new EMF related metric and to trigger measurement reports with regards to the EMF impact.

The new EMF-based measurement reports allow the cell selection/reselection process to take into account minimization or optimization of the EMF impact on the environment (in particular other persons in the vicinity of the terminal). The invention can in particular alleviate people's concerns towards EMF exposure, and make the network rollout easier for operators.

The term “cell” used above is to be interpreted broadly, and may include, for example, the communication range of a transmission point or access point. As mentioned earlier, cells are normally provided by base stations. It is envisaged that the base stations will typically take the form proposed for implementation in the 3GPP LTE and 3GPP LTE-A groups of standards, and may therefore be described as an eNB (eNodeB) (which term also embraces Home eNB or HeNB) as appropriate in different situations. However, subject to the functional requirements of the invention, some or all base stations may take any other form suitable for transmitting and receiving signals from other stations.

The “terminal” referred to above may take the form of a user equipment (UE), subscriber station (SS), or a mobile station (MS), or any other suitable fixed-position or movable form. For the purpose of visualising the invention, it may be convenient to imagine the terminal as a mobile handset (and in many instances at least some of the terminals will comprise mobile handsets), however no limitation whatsoever is to be implied from this. In particular it should be noted that not all terminals in the system need have human users. The system may also comprise so-called Machine-Type Communication (MTC) devices such as vending machines, smart meters and the like.

The apparatus according to preferred embodiments is described as configured or arranged to carry out certain functions. This configuration or arrangement could be by use of hardware or middleware or any other suitable system. In preferred embodiments, the configuration or arrangement is by software.

According to a further aspect there is provided non-transitory computer-readable recording media storing a program which, when loaded onto a terminal configures the terminal to carry out the method steps according to any of the preceding method definitions or any combination thereof.

In general the hardware mentioned may comprise the elements listed as being configured or arranged to provide the functions defined. For example this hardware may include a receiver, a transmitter (or a combined transceiver), a processor, memory/storage medium, a user interface and other hardware components generally found in a terminal.

The invention can be implemented in digital electronic circuitry, or in computer hardware, firmware, software, or in combinations of them. The invention can be implemented as a computer program or computer program product, i.e., a computer program tangibly embodied in an information carrier, e.g., in a machine-readable storage device or in a propagated signal, for execution by, or to control the operation of, one or more hardware modules. A computer program can be in the form of a stand-alone program, a computer program portion or more than one computer program and can be written in any form of programming language, including compiled or interpreted languages, and it can be deployed in any form, including as a stand-alone program or as a module, component, subroutine, or other unit suitable for use in a data processing environment. A computer program can be deployed to be executed on one module or on multiple modules at one site or distributed across multiple sites on the vehicle or in the back-end system and interconnected by a communication network.

Method steps of the invention can be performed by one or more programmable processors executing a computer program to perform functions of the invention by operating on input data and generating output data.

The invention is described in terms of particular embodiments. Other embodiments are within the scope of the following claims. For example, the steps of the invention can be performed in a different order and still achieve desirable results.

### BRIEF DESCRIPTION OF THE DRAWINGS

Reference is made, by way of example only, to the accompanying drawings in which:

FIG. 1 illustrates a basic system architecture in LTE;

FIG. 2 illustrates a Small Cell Network, SCN;

FIG. 3 shows the various channels in LTE;

FIG. 4 illustrates a first example of the EMF impact arising from communication of a UE with two base stations;

FIG. 5 illustrates a second example of the EMF impact arising from communication of a UE with two base stations;

FIG. 6 is a flowchart of steps in a method embodying the present invention;

FIG. 7 is a schematic block diagram of a terminal to which the present invention may be applied; and

FIG. 8 is a schematic block diagram of a base station to which the present invention may be applied.

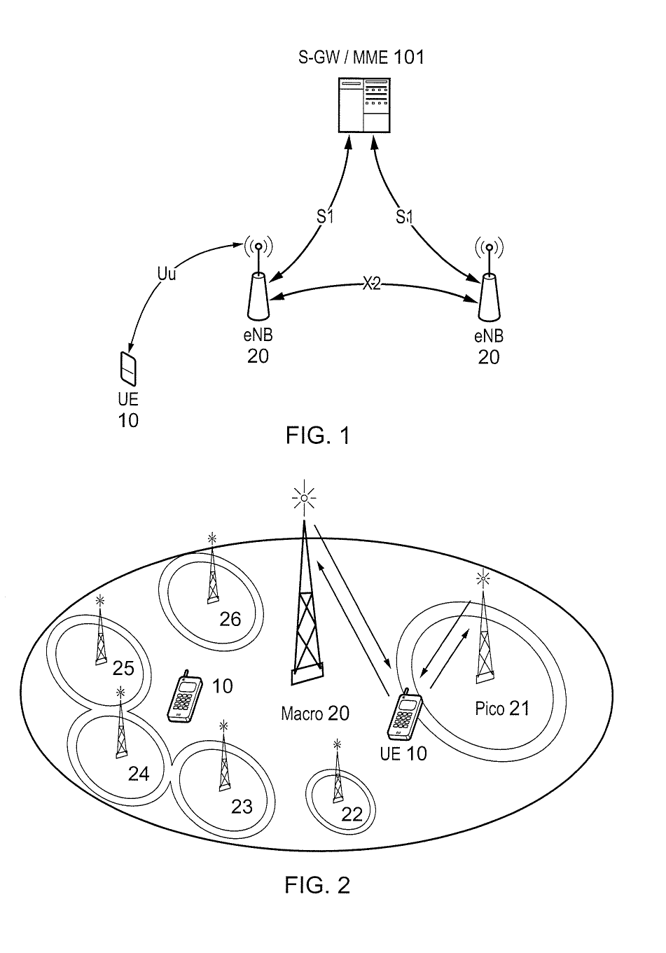

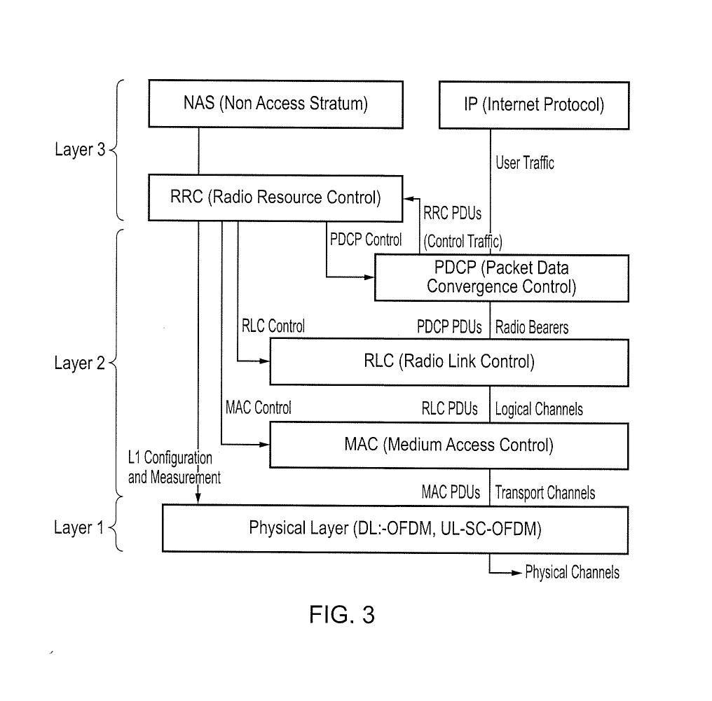

### DETAILED DESCRIPTION

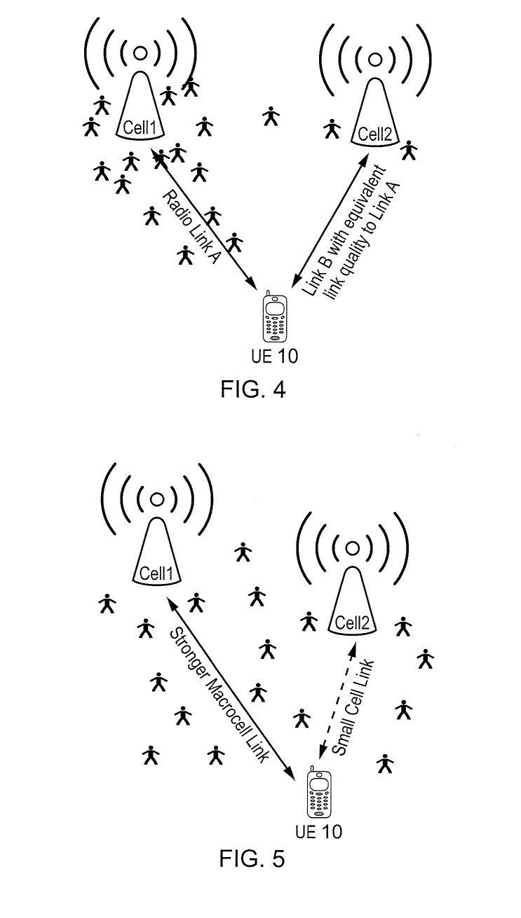

Before describing embodiments of the present invention, the problem being addressed will be further explained with respect to FIGS. 4 and 5.

FIG. 4 shows a UE 10 with two cells, Cell 1 and Cell 2 available to the UE to camp on. We assume that the transmission power and other transmission parameters and radio link path losses are similar for both cells.

The difference between Cell 1 and Cell 2 is not their radio channel quality to the UE, but the potential EMF impact on surrounding persons, once the UE is served by a cell with the subsequent UL and DL transmissions. FIG. 4 indicates that the DL transmissions in Cell 1 are likely to have higher EMF impact on the surrounding humans, as more people are located near the transmission path. Cell 2 is shown to have much fewer people in the vicinity of the transmission path. (Another way to express this is that fewer people are located within the geographical area covered by Cell 2, compared with Cell 1). Therefore the network may prefer that the UE is served by Cell 2 rather than Cell 1. Here, “served” can refer to transmissions on the DL, UL, or both.

In a second example shown in FIG. 5, we assume that Cell 2 is a small cell with a lower power transmitter. Cell 1 has a stronger radio signal at the UE, and thus can support a higher data rate. Cell 2 has a weaker radio signal at the UE because it has a lower transmitter power, which is only partly offset by the reduced pathloss from the smaller cell size. However, in the uplink the UE would require less power to transmit to Cell 2, which would lead to lower EMF.

What is required are one or more mechanisms to enable the selection of a cell based at least partly on the potential or possible EMF impact upon persons in the vicinity.

Embodiments of the present invention address the problem, by adding the following features to a system like LTE:—
The possibility of predicting or estimating EMF impact resulting from use of a cell in the UL and/or DL
Provision of information to the UE to:
   Support the determination of EMF in the UL and/or DL (e.g. broadcast of transmission parameters per cell)
   Support the determination of EMF impact on the particular user, or other users in general (e.g. based on indication of the presence of humans per cell)
Inclusion of EMF in the UE event-triggered measurement reporting criteria
Configuration of EMF-based measurement reporting by the UE (e.g. including measurements or estimates of EMF)
UE capabilities, e.g. in terms of support for EMF-based measurement reporting

Here, the “indication of the presence of humans per cell” may at its most basic be based on the number of mobile telephone users in the cell. In this case it is important to distinguish between UEs which have human users and other UEs (such as MTC devices) which do not. This can be done on the basis of UE category for example, which is known to the network. Certain categories are reserved for MTC devices and become known to the network either during connection of the UE to a cell as part of RRC signalling, or following a specific capability enquiry to the UE.

More generally an attempt may be made to estimate the actual number of humans in the geographical area covered by the cell, based not only on users of mobile devices but also on other information such as surveillance/CCTV systems, or information provided by a database (possibly third party), or by providing the network with some default assumptions.

To facilitate making the UE aware of the potential EMF impact from its serving cell and the potential impact of being served by neighbour cells, a new DL message could be provided. There are a number of possibilities for the design of this message. One choice is a DL broadcast message from each of the cells to inform the UE about the potential EMF impact. One way to convey this message is to broadcast the information from the eNB; for example it may be delivered as part of system information (SI).

Meanwhile, in the uplink, the UEs may gain insight of the potential UL EMF impact by the following methods. The first is to measure the pathloss, so that the UE can estimate the power level required for the relevant UL. That is, by measuring the DL pathloss, the UE can normally expect the UL pathloss to be the same or similar, and estimate the required transmit power accordingly. A second possibility requires the UE to understand if the cell has particular receiver capabilities, such as the capability of receiving reference signals for uplink beamforming/|MIMO. If a UE can transmit on the uplink using beamforming, then the difference in the parameters chosen can make a difference in the UL EMF impact. To facilitate this, it may be helpful for the cells to indicate to the UEs their capability to receive UL beamforming. This will involve an indication of hardware available at the relevant eNB and whether it is configured to receive UL beamforming.

In general, unless otherwise indicated, the embodiments described below are based on LTE, where the network comprises multiple eNodeBs, each controlling one or more downlink cells, and at least some of the downlink cells having a corresponding uplink cell. Each DL cell may serve one or more terminals (UEs) which may receive and decode signals transmitted in that serving cell. When a UE experiences changes in channel conditions to the serving cell and the neighbour cells, measurement reporting to the network may be triggered at the UE.

In a first embodiment, each cell will broadcast a DL EMF indicator in a System Information Block (SIB), while the UEs in range will monitor and decode the information from each cell. This indicates to the UE the DL EMF, relative to other cells or a defined reference, expected to result from a UE receiving DL transmissions from the cell. The UE can then calculate a DL EMF impact metric which could be based on one or more of the following parameters:

(a) DL EMF indicator
(b) Expected data rate
(c) Expected duration of transmission
(d) Transmission power of the cell

### (e) Pathloss to the UE

(f) Interference level at the UE receiver
(g) Number of transmit antennas (or antenna ports) at the eNB
(h) Number of people within the cell coverage area and (preferably) their weighted average distance to the eNB. (i) referenceSignalPower (see TS36.331 section 6.3.2, hereby incorporated by reference)

Any of the above parameters may be determined by (or already known to) the UE, signalled to the UE, obtained by the UE consulting a database of parameters relevant to its current location, or simply assumed by the UE in dependence on system parameters, for example on the basis of frequency band in use

Here, the “Expected data rate” refers to the UE's own service demands and thus will already be known by the UE. The “Expected duration” means the expected duration of DL transmission either of data demanded by the UE, or pushed to the UE by the network. The “Transmission power of the cell” is the power as transmitted by the eNB, and can be signalled to the UE. The “Pathloss to the UE” and “Interference level at the UE receiver” can be measured by the UE. The “Number of transmit antennas at the eNB” can be signalled to the UE as part of a SIB, and is one example of a UL beamforming reception capability indicator.

The “Number of people within the cell coverage area” can, as already mentioned, be based on mobile users or more generally may count all humans in the cell whether or not they are mobile telephone users. It is first calculated by the network and then signalled to the UE. It should be noted that this parameter is not necessarily the actual count of persons in the cell. It may for example be a combination of a density of people and the cell size. A weighting factor could reflect the change in EMF with distance, to take account of the fact that EMF exposure decreases with the square of the distance from a transmitter.

The “referenceSignalPower” is transmitted by the eNB as part of SIB2, allowing the UE to calculated the pathloss: Pathloss=referenceSignalPower—higher layer filtered RSRP. The Reference-signal power, provides the downlink reference-signal EPRE, as the actual value in dBm. Please refer to TS 36.213 section 23.5.2, also incorporated by reference. One possibility is that in addition to the EPRE as part of SIB2 the DL EMF indicator relative to neighbour cells is also transmitted.

The DL EMF indicator is preferably a simple and short message of a few bits, for example in a form like a CQI, or like one information element (IE) in an RRM measurement report. The DL EMF indicator may take any of direct, relative, or indirect forms. As an example of a direct indication, the DL EMF indicator may be a numerical value on a scale of 0 to 15 with 0 representing least EMF impact and 15 the greatest. The relative indication does not directly indicate the severity of EMF but rather a severity relative to a predetermined reference. The indirect indication may be information which is primarily intended for a different purpose but which the UE can use in calculating the impact metric, such as DL transmission power from a cell. A low DL power level would suggest a small cell with few users, which implies a low value of UL EMF impact metric (i.e. a low impact on just a few users).

As will be apparent from the above explanation, there is some overlap between the DL EMF indicator and the other parameters listed. The DL EMF indicator may combine one or more of the other parameters in the list (where these parameters relate to information known to the network), or alternatively the DL EMF indicator need not necessarily be included as a distinct parameter.

The UE uses the information listed above to calculate a “DL impact metric”. This can be thought of as a “score” which is then used by the UE to initiate measurement and reporting, and/or to attempt to connect with a cell. This DL impact metric is used by the UE in addition to, or possibly in place of, the conventional measurement/reporting criteria mentioned in the introduction.

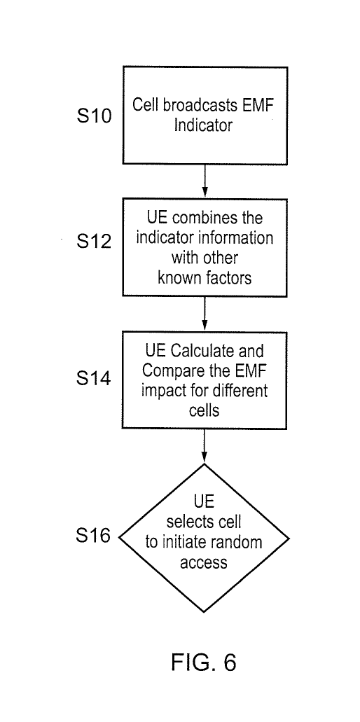

One possible procedure in the downlink for the embodiments is shown in FIG. 6, which is applicable to both scenarios illustrated in FIGS. 4 and 5.

In a first step S10, the cell of interest broadcasts system information including the DL EMF indicator and/or any of the parameters listed above and which are known to the network, such as (a), (d), (g), (h) and/or (i). In step S12 the UE combines the broadcast information with information it knows or can derive from other sources, such as parameters (b), (c), (e) and/or (f), to derive the DL impact metric. In step S14, the UE compares the DL impact metric it has derived for each of a plurality of cells. In S16, the UE uses the comparison of EMF impacts to select a cell with which to initiate random access. Here, the DL impact metric may be one factor balanced among other factors (such as data rate) or may be the sole factor used in the selection.

The process shown in FIG. 6 may be repeated periodically, or triggered every time a cell broadcasts the DL EMF indicator.

As an optional part of the first embodiment, the UE may select a cell for a random access attempt at least partly based on the DL EMF impact metrics for different cells.

As an optional part of the first embodiment, the DL EMF indicator may be calculated by the eNB from information on the values of referenceSignalPower from neighbourhood eNBs which are obtained from network Operation and Maintenance signal (O&M) or by the X2 interface.

The calculation of the DL EMF indicator may also be determined in the eNB by using the normal RRM reporting procedure for UEs connected to the eNB but with either normal MDT (Minimisation of drive tests) or RRM type measurements modified to include not only RSSI but also the values of referenceSignalPower from the measured cells.

As an optional part of the first embodiment, at least one criterion for event-based triggering UE measurement reports is dependent on the DL impact metric for the concerned cells. A new EMF-based criterion is constructed in a manner analogous to the conventional criteria mentioned earlier, by comparing the DL impact metric with a threshold value (which may be configured by the network, or may be a preset value, or set by the user). If this new EMF relevant criterion is met or exceeded, then the UE will trigger a measurement report for handover purposes or other purposes. This new criterion may either be used alone, or in combination with one or more conventional criteria. For example a measurement report may be triggered when both the new EMF-based criterion and a conventional signal strength criterion (Event A1, A2 etc.) are satisfied.

Examples of such a new EMF-based criterion include, by analogy with the Event A1 etc. defined conventionally:
Serving cell becomes worse than absolute threshold in terms of EMF impact metric
Neighbour cell becomes better than an offset relative to the serving cell in terms of EMF impact metric, and so forth.

Thus, the present invention can be used not only to assess an absolute EMF impact caused by a UE using a given cell for DL or UL, but also a change in EMF expected to result from using one cell rather than another. Deriving the DL impact metric can enable the UE to modify its measurement reporting behaviour so that for example, if no improvement in EMF is expected by using another cell, measurement reporting for that cell is inhibited.

In variations of the first embodiment, the information in the DL EMF impact indicator may be supplemented or replaced by signalling specifically to individual UEs.

For example, this would allow the above mentioned parameter “Number of people within the cell coverage area” to be modified to take account of the transmission path to the UE. Knowing the approximate location of the UE, the indication may be weighted towards people in the vicinity of the transmission path (and thus more likely to be affected by EMF from that UE) rather than all persons in the cell (some of whom may be located far from the transmission path). Alternatively or in addition, the eNB may provide, as part of the indication, the weighted average distance of people from the UE.

In variations of the first embodiment, if a DL EMF indicator is not supplied to the UE a default value may apply or a value may be derived from other information, for example the referenceSignalPower obtained from all the cells which the UE can read SIB2 from. It should be noted that absence of the DL EMF indicator as such does not exclude the network providing other information, such as the number of people within the cell coverage area.

A second embodiment is like the first embodiment except that the invention is applied to the uplink. Each cell will broadcast an UL EMF indicator in a System Information Block (SIB).

An optional but not compulsory feature is that the cells will include their capability information e.g. on UL beamforming/MIMO, or use of higher-order modulation in a SIB.

The UE can then calculate an UL EMF impact metric which may be based on one or more of the following parameters:

Expected data rate
Expected duration of transmission
Estimated transmission power of the UE

### Pathloss to the eNB

Interference level at the eNB receiver
Reception capabilities of the eNB receiver (e.g. MIMO, high order modulation)
Number of transmit antennas at the UE
Number of people within the UE UL coverage area and their average distance from the UE.

As in the first embodiment the UE may use the UL EMF impact metric in cell selection for an access attempt or for triggering of measurement reports.

A third embodiment combines features from the first and second embodiments, such as signalling UL and/or DL EMF indicators to enable the UE to compute both UL and DL impact metrics. Either or both of these may be used for cell selection and/or triggering of measurement reports etc.

In variations of the embodiments an absolute EMF impact is determined, such as a combination of DL and UL impact metrics.

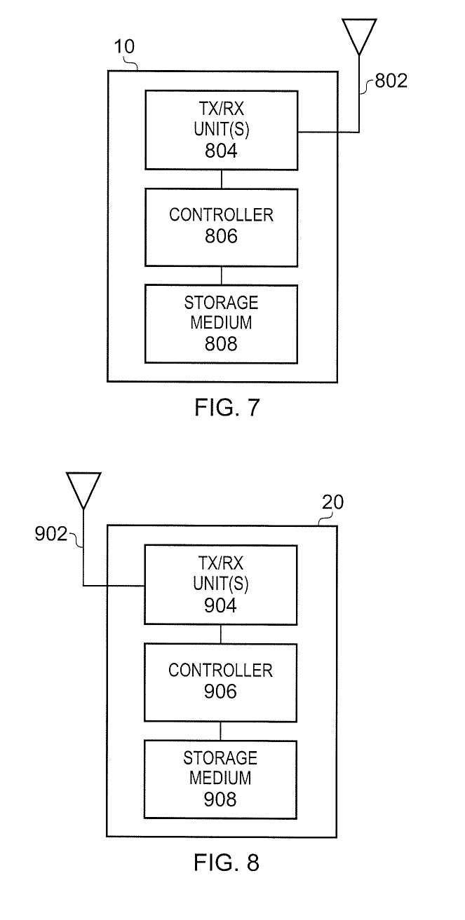

FIG. 7 is a block diagram illustrating an example of a UE 10 to which the present invention may be applied. The UE 10 may include any type of device which may be used in a wireless communication system described above and may include cellular (or cell) phones (including smartphones), personal digital assistants (PDAs) with mobile communication capabilities, laptops or computer systems with mobile communication components, and/or any device that is operable to communicate wirelessly. The UE 10 includes transmitter/receiver unit(s) 804 connected to at least one antenna 802 (together defining a communication unit) and a controller 806 having access to memory in the form of a storage medium 808. The controller 806 may be, for example, a microprocessor, digital signal processor (DSP), application-specific integrated circuit (ASIC), field-programmable gate array (FPGA), or other logic circuitry programmed or otherwise configured to perform the various functions described above, for example to calculate the above mentioned DL and/or UL impact metric. For example, the various functions described above may be embodied in the form of a computer program stored in the storage medium 808 and executed by the controller 806. The transmission/reception unit 804 is arranged, under control of the controller 806, to receive broadcast and UE-specific messages from the cells, including the above mentioned EMF indicators, and send measurement reports and so forth as discussed previously.

FIG. 8 is a block diagram illustrating an example of an eNB 20. It includes transmitter/receiver unit(s) 904 connected to at least one antenna 902 (together defining a communication unit) and a controller 906. The controller may be, for example, a microprocessor, DSP, ASIC, FPGA, or other logic circuitry programmed or otherwise configured to perform the various functions described above, including deriving the DL EMF indicator referred to above. For example, the various functions described above may be embodied in the form of a computer program stored in the storage medium 908 and executed by the controller 906. The transmission/reception unit 904 is responsible for transmission of the control messages and so on under control of the controller 906.

To summarise, embodiments of the present invention provide for a mobile terminal (UE) to report measurements or select cells based on the EMF estimated to result on the uplink and/or downlink due to the UE's use of those cells (that is, EMF either caused by the eNB of the cell transmitting to the UE on the DL, or by the UE itself by its UL transmissions). One supporting feature is a downlink signalling mechanism to allow the network to send indications to the UE, in order to allow UE to understand the EMF impact generated when the UE is connected to certain cells. The specific indication discussed is, in the downlink, an EMF impact indicator or a UL beamforming reception capability indicator. For application to LTE, a new event triggered UE measurement reporting criterion is proposed to allow the UE to report measurements based on a new EMF related metric and to trigger measurement reports with regards to the EMF impact.

Various modifications are possible within the scope of the present invention.

In FIG. 6 it was assumed that the UE has a plurality of cells available from which it can select for providing a certain DL transmission. However, the present invention can be usefully applied even in the context of a single cell, to allow the user to check the expected EMF impact of a given service. For example, if the user wishes to download a video he or she may wish to check the EMF impact of doing so upon other persons in the vicinity, and possibly change their behaviour (for example, wait until another time when fewer people are present) before initiating the download. Another possibility is for the user to perform a setting on the UE giving priority to achieving low EMF, similar to the existing power management settings available on many portable devices.

For convenience, the invention has been described with respect to specific cells. However, the invention can be applied without the necessity for cells, and may be described in terms of the communications between different stations (including base stations supporting cells, mobile stations (e.g. D2D), and other types of station such as relays, and to communication via Remote Radio Heads of base stations).

The invention is equally applicable to LTE FDD and TDD, and to mixed TDD/FDD implementations (i.e. not restricted to cells of the same FDD/TDD type). The principle can be applied to other communications systems such as UMTS or Wi-Fi. Accordingly, references in the claims to a “terminal” are intended to cover any kind of user device, subscriber station, mobile terminal and the like and are not restricted to the UE of LTE.

As already mentioned, terminals in a wireless communication system may include MTC devices. The present invention may be applied to transmission/reception by MTC devices, for example to influence which cell an MTC device connects to, or to modify transmission/reception if a high EMF impact metric is calculated. Generally MTC device communications are not time-critical and therefore, for example, may be postponed until fewer users are in the vicinity and the EMF impact is reduced.

The above embodiments of the present invention target EMF exposure to persons in the vicinity of the terminal, rather than to the user him- or herself. However, if desired the EMF exposure to the user could also be taken into account for example when selecting a cell for handover. Also, the potential for EMF exposure other than to humans, such as to animals, or to sensitive electronic equipment for example in hospitals, may also be taken into account.

In any of the aspects or embodiments of the invention described above, the various features may be implemented in hardware, or as software modules running on one or more processors. Features of one aspect may be applied to any of the other aspects.

The invention also provides a computer program or a computer program product for carrying out any of the methods described herein, and a computer readable medium having stored thereon a program for carrying out any of the methods described herein.

A computer program embodying the invention may be stored on a computer-readable medium, or it may, for example, be in the form of a signal such as a downloadable data signal provided from an Internet website, or it may be in any other form.

It is to be clearly understood that various changes and/or modifications may be made to the particular embodiments just described without departing from the scope of the claims.

### INDUSTRIAL APPLICABILITY

The new EMF-based measurement reports allow the cell selection/reselection process to take into account minimization or optimization of the EMF impact on the environment. The invention can in particular alleviate people's concerns towards to EMF exposure, and make the network rollout easier for operators.

1. A terminal for use in a wireless communication network having one or more cells at least one of which is a serving cell or potential serving cell for the terminal and has a coverage area occupied by one or more persons at least one of whom is not a user of the terminal, the terminal comprising:
a receiver which receives messages from the network including, for each of said at least one said cell, an indication related to electromagnetic field, EMF, exposure; and
a controller which estimates, based at least on said indication, an EMF impact on at least one of said one or more persons of the terminal performing wireless communication on a downlink and/or on an uplink with said at least one said cell.

2. The terminal according to claim 1, the controller further configured for generating a measurement report related to the estimated EMF impact either unconditionally or if the estimated EMF impact fulfils a criterion.

3. The terminal according to claim 2 wherein the measurement report includes an indication of the estimated EMF impact.

4. The terminal according to claim 1 wherein the controller is further arranged for selecting a cell on the basis of at least an estimated EMF impact.

5. The terminal according to claim 1 wherein the indication indicates an EMF level expected to result from the terminal receiving a transmission from the cell.

6. The terminal according to claim 1 wherein the controller performs said estimating using at least one of:
data rate expected by the terminal;
duration of transmission expected by the terminal;
transmission power of the cell and/or of the terminal;
pathloss to the terminal and/or to the cell;
interference level at the terminal or at receive antennas of the cell;
number of transmit antennas, or antenna ports, of the cell and/or of the terminal;
number of persons within the cell coverage area and their average distance from the terminal or from transmit antennas of the cell; and
reference signal power.

7. A base station providing at least one cell in a wireless communication network, the base station comprising:
a controller which obtains an indication related to EMF exposure for each of said at least one cell; and
a transmitter which transmits the indication to at least one terminal.

8. The base station according to claim 7 wherein the transmitter is arranged to transmit the indication in system information broadcast by the base station.

9. The base station according to claim 7 wherein the transmitter is arranged to transmit the indication by specific signalling to the terminal.

10. The base station according to claim 7 wherein the indication includes at least one of:
a direct or relative indication of an EMF level expected to result from the terminal receiving a transmission from the at least one cell;
an indication of transmission characteristics of DL transmissions from the at least one cell;
an indication of UL reception capability of the at least one cell; and
an indication of a number of persons within the at least one cell; and
an indication of a number of persons in the vicinity of a transmission path to or from the terminal.

11. The base station according to claim 7 further comprising receiver arranged to receive, from the terminal, a measurement report which includes an indication of EMF impact estimated on the basis of the indication.

12. The base station according to claim 7 wherein the controller obtains values of reference signal power for cells provided by other base stations in the network.

13. The base station according to claim 7 wherein the controller obtains measurements of received power from terminals served by cells provided by the base station.

14. A wireless communication system comprising at least one terminal according to claim 1 and at least one base station according to claim 7.

15. A wireless communication method comprising:
at a base station, obtaining an indication related to EMF exposure for each of at least one cell, and transmitting the indication to a terminal;
and at the terminal, receiving said indication and estimating, based at least on said indication, an EMF impact on one or more persons of the terminal performing wireless communication on a downlink and/or on an uplink with said at least one said cell.
